(19) United States
(12) Patent Application Publication
(10) Pub. No.: US 2017/0024492 A1
(43) Pub. Date: Jan. 26, 2017

(54) METHOD AND APPARATUS FOR MODELING AND RESTORING TARGET OBJECT USING PRE-COMPUTATION

(71) Applicant: Samsung Electronics Co., Ltd., Suwon-si (KR)

(72) Inventors: Jiyeon KIM, Hwaseong-si (KR); Nahyup KANG, Seoul (KR); Donghoon SAGONG, Suwon-si (KR); Hyong Euk LEE, Suwon-si (KR); Hwiryong JUNG, Seoul (KR)

(73) Assignee: Samsung Electronics Co., Ltd., Suwon-si (KR)

(21) Appl. No.: 15/178,914

(22) Filed: Jun. 10, 2016

(30) Foreign Application Priority Data
Jul. 23, 2015 (KR) 10-2015-0104256

(51) Int. Cl. G06F 17/50; G06T 17/10

(52) U.S. Cl. CPC G06F 17/50; G06T 17/10

(57) ABSTRACT

Provided is a method and apparatus for modeling and restoring a target object, the method including generating a key structure of the target object based on deformation information of the target object extracted from a pre-modeling result based on a shape and a material property of the target object, and calculating a virtual material property corresponding to the key structure based on the virtual material property and the key structure of the target object.

### CROSS-REFERENCE TO RELATED APPLICATION(S)

This application claims the benefit under 35 USC §119(a) of Korean Patent Application No. 10-2015-0104256, filed on Jul. 23, 2015, in the Korean Intellectual Property Office, the entire disclosure of which is incorporated herein by reference for all purposes.

### BACKGROUND

1. Field

The following description relates to a method and apparatus for modeling and restoring a target object using a pre-computation.

2. Description of Related Art

In the field of computer graphics (CG), such as, in visual effects (VFX), a target object to be modeled may be classified into a rigid body, a deformable body, a fluid, or a combination thereof.

When a target object is modeled based on its particles, a movement and a deformation of the target object may be reflected based on a distribution of the particles in an entire area of the target object and computing positions of entire particles for every frame. Since the positions of the entire particles are found and computed for every frame, a considerable amount of computing time is required. Therefore, a real-time representation of the movement and the deformation of the target object to be similar to a reality may be cumbersome and require extensive computing resources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of modeling a target object, the method including extracting deformation information of a target object from a result of pre-modeling based on a shape and a material property of the target object, generating a key structure of the target object based on the deformation information, and calculating a virtual material property corresponding to the key structure.

The deformation information of the target object may include determining a modeling set for observing a deformation of the target object based on the shape and the material property of the target object, and performing the pre-modeling on the modeling set.

The determining of the modeling set may include determining the modeling set based on at least one of a force of gravity, an external user force, an interaction force by a fluid, or an elastic force applicable to the target object.

The deformation information may include at least one of rotation information or stretch information on elements configuring the target object.

The generating of the key structure may include generating the key structure based on at least one element of a particle, a beam based on a physical connectivity between particles, or a three-dimensional (3D) mesh.

The generating of the key structure of the target object may include clustering a similar area from the result of the pre-modeling based on the deformation information, generating a representative particle for each cluster on which the clustering is performed, and generating the key structure by connecting a representative particle of a first cluster on which the clustering is performed to a representative particle of a second cluster neighboring the first cluster.

The clustering may include clustering the similar area from the result of the pre-modeling based on a similarity of the deformation information.

The generating of the representative particle may include calculating a center of gravity in the cluster, and generating the representative particle at a position corresponding to the center of gravity.

The generating of the key structure may include generating the key structure of the target object by connecting the representative particle of the first cluster to the representative particle of the second cluster, in response to the deformation information between the representative particle of the first cluster and the representative particle of the second cluster being consecutive.

The calculating of the virtual material property may include calculating deformation information per unit external force affecting the representative particle, and assigning, as the virtual material property, the deformation information per unit external force to the representative particle.

The method may include calculating a weight to quantify an influence of the representative particle on adjacent particles within a range in which the representative particle exhibits an effect.

The range in which the representative particle exhibits an effect may include at least one of the second cluster neighboring the first cluster including the representative particle, or a third cluster connected to the second cluster.

In accordance with another general aspect, there is provided a method of restoring a target object, the method including receiving a key structure of a target object and a virtual material property corresponding to the key structure, applying the virtual material property and the key structure to a governing equation corresponding to an external force applied to the target object to deform the virtual material property and the key structure, and restoring the target object to which the governing equation is applied based on the deformed virtual material property and the deformed key structure.

The method may include receiving a weight to quantify an influence between particles in the key structure, wherein the restoring of the target object includes restoring the target object based on the deformed key structure, the deformed virtual material property, and the weight.

The key structure may be generated based on at least one element of a particle, a beam based on a physical connectivity between particles, or a three-dimensional (3D) mesh.

The key structure of the target object may be generated by clustering a similar area from a result of pre-modeling based on the deformation information, generating a representative particle for each cluster on which the clustering is performed, and connecting a representative particle of a first cluster on which the clustering is performed to a representative particle of a second cluster neighboring the first cluster.

The virtual material property may include deformation information per unit external force affecting a particle included in the key structure.

In accordance with another general aspect, there is provided an apparatus for modeling a target object, the apparatus including a memory configured to store a shape and a material property of a target object, and a processor configured to extract deformation information of the target object from a result of premodeling based on the shape and the material property of the target object, to generate a key structure of the target object based on the deformation information, and to calculate a virtual material property corresponding to the key structure.

In accordance with another general aspect, there is provided an apparatus for restoring a target object, the apparatus including a memory configured to store a key structure of a target object and a virtual material property corresponding to the key structure, and a processor configured to deform the virtual material property and the key structure by applying the virtual material property and the key structure to a governing equation corresponding to an external force applied to the target object, and to restore the target object to which the governing equation is applied based on the deformed virtual material property and the deformed key structure.

Other features and aspects will be apparent from the following detailed description, the drawings, and the claims.

### BRIEF DESCRIPTION OF THE DRAWINGS

FIG. 1 is a diagram illustrating an example of an apparatus for modeling a target object.

FIG. 2 is a diagram illustrating an example of a method of modeling a target object.

FIG. 3 is a diagram illustrating an example of a method of extracting deformation information of a target object.

FIG. 4 is a diagram illustrating an example of a method of generating a key structure of a target object.

FIGS. 5A and 5B are diagrams illustrating illustrate examples of a method of clustering a similar area.

FIG. 6 is a diagram illustrating an example of performing an exceptional processing during clustering.

FIGS. 7A and 7B are diagram illustrating examples of a key structure of a target object generated.

FIG. 8 is a diagram illustrating an example of a method of calculating a weighting between a representative particle and adjacent particles.

FIG. 9 is a diagram illustrating an example of a method of modeling a target object.

FIG. 10 is a diagram illustrating an example of a method of modeling a target object by applying a governing equation.

FIG. 11 is a diagram illustrating an example of a full restoration result.

FIG. 12 is a diagram illustrating an example of an apparatus for modeling a target object.

FIG. 13 is a diagram illustrating an example of a method of restoring a target object.

FIG. 14 is a diagram illustrating an example of an apparatus for restoring a target object.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “include/comprise” and/or “have” when used in this specification, specify the presence of stated features, integers, steps, operations, elements, components, and/or combinations thereof, but do not preclude the presence or addition of one or more other features, numbers, steps, operations, elements, components, and/or groups thereof.

When describing the examples with reference to the accompanying drawings, like reference numerals refer to like constituent elements and a repeated description related thereto will be omitted. When it is determined detailed description related to a related known function or configuration they may make the purpose of the examples unnecessarily ambiguous in describing the examples, the detailed description will be omitted here.

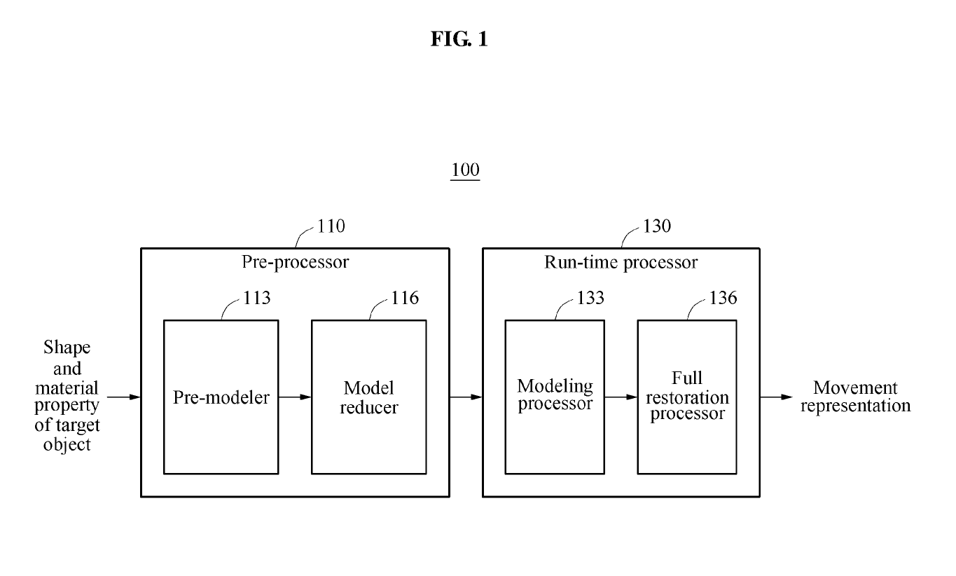

FIG. 1 is a diagram illustrating an example of an apparatus for modeling a target object.

Referring to FIG. 1, an apparatus for modeling a target object 100, hereinafter, referred to as a “modeling apparatus 100,” which models a target object through a pre-processor 110 and a run-time processor 130.

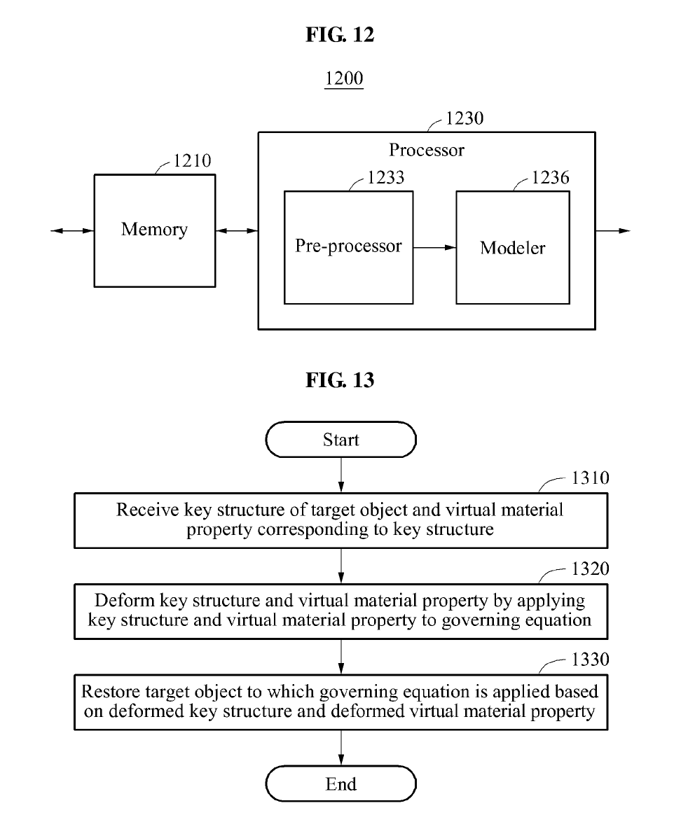

The pre-processor 110 may be implemented by one or more processors or elements such as, for example, a pre-processor 1233 in FIG. 12. Likewise, the run-time processor 130 may be implemented by one or more processors or elements such as, for example, a modeler 1236 in FIG. 12. The pre-processor 110 is performs “pre-computation.”

In the pre-processor 110, the modeling apparatus 100 generates a key structure of a target object to be modeled and calculates a virtual material property corresponding to the key structure. The modeling apparatus 100 may reduce a model of the target object by applying the calculated virtual material property to the key structure of the target object. In this example, “reducing” the model of the target object may be modeling a key structure corresponding to a key shape of the target object in lieu of modeling a full model of the target object. Further, in the pre-processor 110, the modeling apparatus 100 calculates a weighting quantifying an influence of a representative particle configuring the key structure of the target object on adjacent particles. The adjacent particles may be particles within a range in which the representative particle exhibits an effect. The weighting calculated in the pre-processor 110 may be used for full restoration of the target object in the run-time processor 130.

The pre-processor 110 includes a pre-modeler 113 and a model reducer 116.

The pre-modeler 113 of the modeling apparatus 100 may perform pre-modeling with respect to various circumstances, such as, for example, a collision, a twist, and dropping, to observe a deformation of the target object. In an example, the pre-moder 113 may model an entirety of a target object, for example, a full model. Although time for modeling the target object is required, limitations on computing time are relatively small since the pre-modeling by the pre-modeler 113 is performed in the pre-processor 110.

The model reducer 116 of the modeling apparatus 100 performs model reduction on the target object based on information, such as, for example, deformation information, extracted from the pre-modeler 113. During the model reduction, the model reducer 116 of the modeling apparatus 100 generates the key structure in a form in which an actual target object is reduced. For example, the key structure may be provided in coarse particles, or a three-dimensional (3D) mesh form, such as tetrahedral mesh, or a beam based on a physical connectivity between particles.

The model reducer 116 of the modeling apparatus 100 verifies a similar area from the result of the pre-modeler 113 based on the deformation information and generates a virtual representative particle for each cluster by clustering the similar area. The modeling apparatus 100 generates the key structure by connecting representative particles. The modeling apparatus 100 calculates the virtual material property based on a material property of a corresponding cluster and applies the virtual material property to the representative particle.

The model reducer 116 of the modeling apparatus 100 calculates a weighting based on distances between the representative particle and all adjacent particles within a range in which the representative particle exhibits an effect. The weighting may be understood as a value quantifying an influence of the representative particle on the adjacent particles.

The run-time processor 130 of the modeling apparatus 100 computes a movement of the target object similar to a real movement using a governing equation based on the key structure to which the virtual material property calculated in the pre-processor 110 is applied. The modeling apparatus 100 computes the movement and the deformation of the target object for every frame.

In the run-time processor 130, the modeling apparatus 100 may perform a full restoration process at the full restoration processor 136 on the target object and a modeling process at the modeling processor 133 on the key structure every hour. The full restoration process may be a restoration of entire particles configuring the target object in addition to the key structure, when the key structure of the target object is modeled based on particles.

The run-time processor 130 may include the modeling processor 133 and the full restoration processor 136.

In the modeling process performed at the modeling processor 133, the modeling apparatus 100 models movements and deformations in the representative particles configuring the key structure, for example, a movement of a key structure at a time t1. The modeling apparatus 100 performs the full restoration process at the full restoration processor 136 to restore the target object based on a movement of the full model of the target object at the time t1, using the result of the modeling process performed at the modeling processor 133. In the full restoration process at the full restoration processor 136, the modeling apparatus 100 may transfer the weighting calculated in the pre-processor 110 to adjacent elements affected by elements, for example, a particle, a beam, and a mesh, configuring the key structure.

The modeling apparatus 100 may represents, in real-time, a movement of the target object similar to a real movement for every time-step by performing the pre-processing process at the pre-processor 110 and the run-time processing at the run-time processor 130 on a received shape and a material property of the target object. When the modeling apparatus 110 models the target object based on, for example, a particle, the movement of the target object for every time-step may be represented based on positions of entire particles configuring the target object.

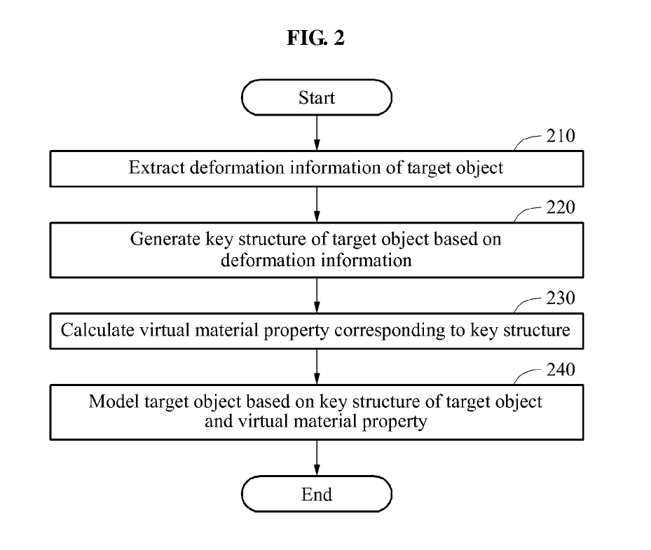

FIG. 2 is a diagram illustrating an example of a method of modeling a target object. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. The above descriptions of FIG. 1 is also applicable to FIG. 2, and is incorporated herein by reference. Thus, the above description may not be repeated here.

Referring to FIG. 2, in 210, the modeling apparatus 100 extracts deformation information of a target object from a pre-modeling result based on a shape and a material property of the target object. In this example, the target object may be a fluid, a deformable body, or a combination of the fluid and the deformable body. The deformable body may include a rigid body and a soft body. The fluid may be understood as including a fluid having a high viscosity, such as, for example, a starch syrup and asphalt, in addition to a fluid having a relatively small viscosity, for example, water.

The material property of the target object may include properties, such as, for example, mass, density, volume, velocity, position, or force of the target object.

For ease of description, a rabbit doll having a shape of a rabbit in rubber material refers to a target object, and pre-modeling is assumed to be performed on the target object based on particles.

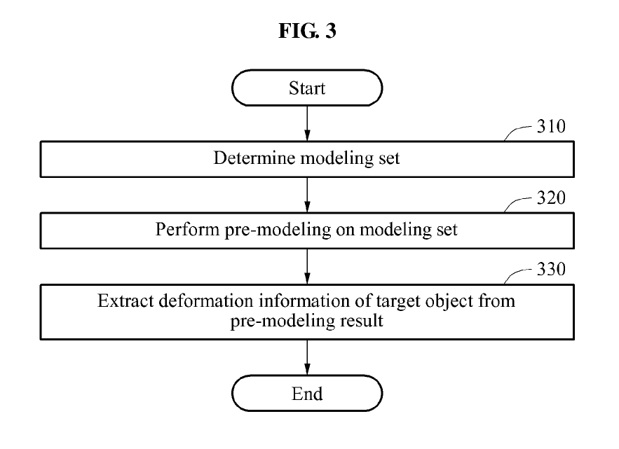

The method of extracting the deformation information of the target object by the modeling apparatus 100 will be described with reference to FIG. 3.

In 220, the modeling apparatus 100 generates a key structure of the target object based on the deformation information extracted in 210. The key structure may be a physically significant model in a form of which an actual target object is reduced. For example, the key structure may correspond to a key shape of the target object.

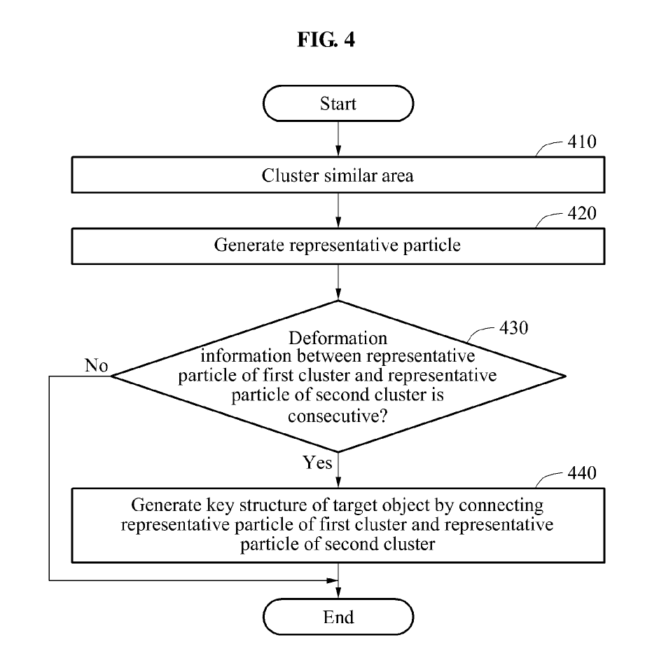

The modeling apparatus 100 generates the key structure of the target object based on at least one element of a particle, a beam based on a physical connectivity between particles, and a 3D mesh. In this example, a particle used as an element may be a coarse particle. The method of generating the key structure of the target object by the modeling apparatus 100 will be described with reference to FIG. 4.

In 230, the modeling apparatus 100 calculates a virtual material property corresponding to the key structure. Since the key structure is in a form of which the actual target object is reduced, the material property of the target object may not be used without a change during modeling based on the key structure.

In 240, the modeling apparatus 100 models the target object based on the key structure of the target object and the virtual material property. The modeling apparatus 100 models a movement and a deformation of the target object by applying the key structure of the target object to which the virtual material property is applied to a governing equation.

The key structure of the target object generated in 220 and the virtual material property calculated in 230 may be transferred to an apparatus for restoring a target object, hereinafter, referred to as a “restoring apparatus,” which is different from the modeling apparatus 100. The restoring apparatus having received the virtual material property and the key structure of the target object from the modeling apparatus 100, applies the virtual material property and the key structure to a governing equation corresponding to an external force applied to the target object. Therefore, the restoring apparatus deforms the virtual material property and the key structure and restores the target object to which the governing equation is applied based on the deformed virtual material property and the deformed key structure. Examples in which the target object is restored by the restoring apparatus will be described with reference to FIG. 13.

FIG. 3 is a diagram illustrating an example of a method of extracting deformation information of a target object. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. The above descriptions of FIGS. 1-2 is also applicable to FIG. 3, and is incorporated herein by reference. Thus, the above description may not be repeated here.

Referring to FIG. 3, in 310, the modeling apparatus 100 determines a modeling set for observing a deformation of a target object based on a shape and a material property of the target object. The modeling apparatus 100 may determine a modeling set based on various forces applicable to the target object in various circumstances, such as, for example, a collision, a twist, or dropping, for observing the deformation of the target object by various forces applicable to the target object. For example, the modeling apparatus 100 may determine the modeling set with respect to each force by dividing force applicable to the target object into a force of gravity, an external user force, an interaction force by a fluid, and an elastic force.

In this example, the external user force may be interconnected to a control of a user from an outside of the modeling apparatus 100. For example, when the modeling apparatus 100 is combined or connected to a head mount display (HMD), an external force applied to the target object may be controlled by a movement of a head of the user. In addition, a movement of the target object may be controlled in response to control information, for example, directions, amounts, and angles of force, input by a joystick. The modeling apparatus 100 may be used for realizing a virtual reality or an augmented reality based on the described methods.

In 320, the modeling apparatus 100 performs pre-modeling on the modeling set. The pre-modeling corresponds to modeling on a full model, for example, an entirety of the target object, in various circumstances. The modeling apparatus 100 may perform pre-modeling for the entirety of the target object for every modeling set.

In 330, the modeling apparatus 100 extracts deformation information of the target object from a result of the pre-modeling in 320. For example, the deformation information may include stretch information and rotation information on elements configuring the target object. The stretch information may be understood as a value indicating a degree by which the elements increase or decrease. The rotation information may be understood as a value indicating a rotation degree of the elements based on any one axis of an X-axis, a Y-axis, and a Z-axis. The rotation information may represent a deformation having a degree similar to a degree of a deformation generated in the elements having correlations. The rotation information may be obtained from every element configuring the target object based on the pre-modeling.

FIG. 4 is a diagram illustrating an example of a method of generating a key structure of a target object in accordance with an embodiment. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. The above descriptions of FIGS. 1-3 is also applicable to FIG. 4, and is incorporated herein by reference. Thus, the above description may not be repeated here.

Referring to FIG. 4, in 410, the modeling apparatus 100 clusters a similar area from a pre-modeling result based on deformation information. The modeling apparatus 100 may cluster the similar area from the pre-modeling result based on a similarity of the deformation information. The modeling apparatus 100 may assign an identical cluster identification (ID) with respect to elements included in the similar area on which the clustering is performed as a single cluster.

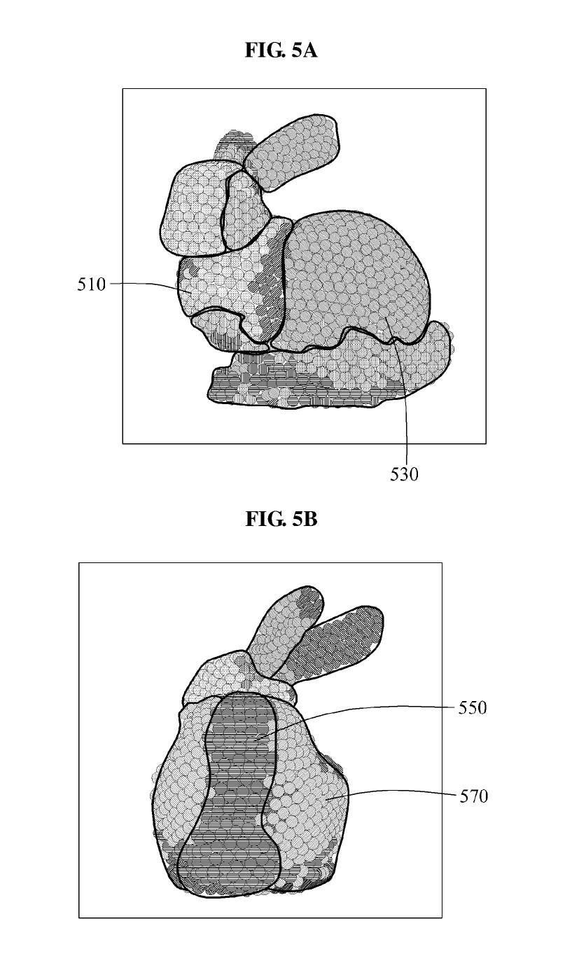

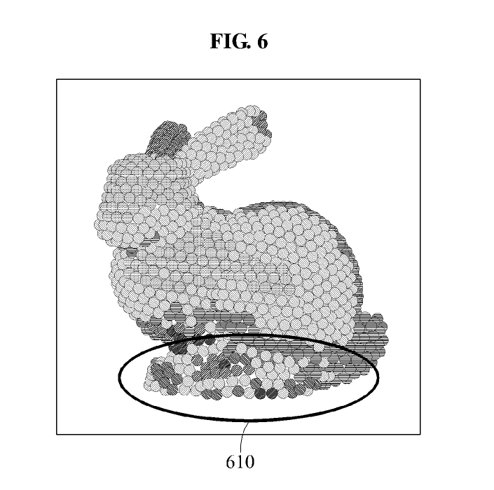

The method of clustering the similar area and a clustering result will be described further with reference to FIGS. 5A, 5B, and 6.

In 420, the modeling apparatus 100 generates a virtual representative particle for each cluster on which the clustering is performed. In an example, the modeling apparatus 100 may generate a representative particle based on a center of gravity in a cluster.

In 430, the modeling apparatus 100 verifies whether deformation information between a representative particle of a first cluster on which the clustering is performed and a representative particle of a second cluster neighboring the first cluster is consecutive. The modeling apparatus 100 may terminate an operation in response to verification that the deformation information is non-consecutive.

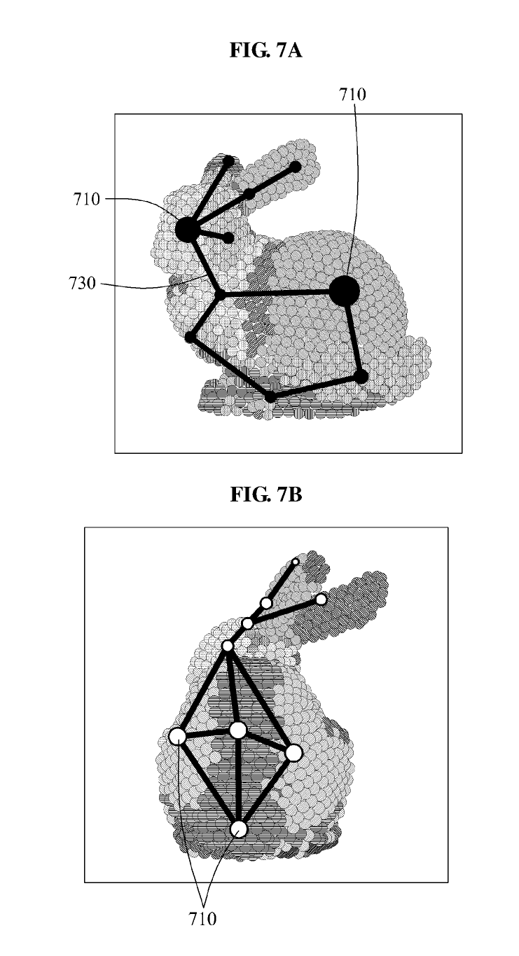

In 440, the modeling apparatus 100 generates a key structure of the target object by connecting the representative particle of the first cluster and the representative particle of the second cluster in response to verification that the deformation information is consecutive in 430. The key structure of the target object generated by the modeling apparatus 100 will be described with reference to FIGS. 7A and 7B.

FIGS. 5A and 5B are diagrams illustrating examples of a method of clustering a similar area.

FIGS. 5A and 5B illustrate an example of a result in which clustering is performed based on a similarity of deformation information. The deformation information may be extracted from a result of pre-modeling of a circumstance in which a rabbit doll is dropped. For example, the deformation information may refer to rotation information based on an X-axis. FIG. 5A illustrates a diagonal view of a result of performing clustering, and FIG. 5B illustrates an example of a back view of the result of the clustering is performed.

Referring to FIG. 5A, when rotation information on a neck portion 510 of a rabbit has a similarity greater than or equal to a threshold, the neck portion 510 of the rabbit may be clustered to be a single cluster. Also, when rotation information on a torso portion 530 of the rabbit has a similarity greater than or equal to the threshold, the torso portion 530 of the rabbit may be clustered to be a single cluster.

Referring to FIG. 5B, a back portion 550 of a rabbit and a torso portion 570 of the rabbit may be clustered based on a similarity of rotation information, respectively.

For example, the pre-modeling performed in an example refers to modeling of a movement and a deformation generated by various forces applicable to a rabbit doll. The movement irrespective of an exercise by a movement of a joint may be modeled. For example, when a rabbit doll is modeled based on particles, each of the clusters illustrated in FIGS. 5A and 5B may be clustered based on a relationship between a shape and adjacent particles of the rabbit doll.

The modeling apparatus 100 may perform clustering based on the relationship between the shape and the adjacent particles of the target object and a movement of a skeleton.

The modeling method may be applied to a target object configured based on various materials, such as, for example, isotropic materials and heterogeneous materials. When the target object is configured based on the heterogeneous materials, the modeling apparatus 100 may perform clustering based on each material property of materials.

A case in which an exceptional processing with respect to the aforementioned clustering method will be described with reference to FIG. 6.

FIG. 6 is a diagram illustrating an example in which an exceptional processing is performed during clustering.

FIG. 6 illustrates deformation information have different values in a predetermined area 610 of a target object. For example, when a rabbit doll makes contact with a floor, a great amount of distortion may be generated in an adjacent portion of a boundary surface at which the rabbit doll makes contact with the floor. The deformation information, for example, rotation information, may be differently generated in each of particles corresponding to the predetermined area 610 in which the great amount of distortion is generated. When the deformation information has a similarity lower than a threshold, the modeling apparatus 100 may have difficulty in performing clustering based on the similarities.

When the similarity of the deformation information of the target object in the predetermined area 610, for example, a portion in which the great amount of distortion is generated, the exceptional processing may be performed with respect to particles included in the predetermined area 610. The modeling apparatus 100 may cluster the predetermined area 610 based on stretch information, other than the rotation information. The modeling apparatus 100 may perform clustering by ignoring particles having stretch information greater than or equal to a threshold value among stretch information of a loading direction on the boundary surface of the floor.

FIGS. 7A and 7B are diagrams illustrating examples of a key structure of a target object generated.

FIG. 7A is a diagram illustrating an example of a key structure of a target object generated based on rotation information on an X-axis. FIG. 7B is a diagram illustrating an example of a key structure of a target object generated based on rotation information on a Z-axis.

For example, the modeling apparatus 100 calculates a center of gravity in each cluster and determine a position corresponding to the center of gravity as a representative position. The modeling apparatus 100 generates representative particles 710 at representative positions. In this example, the representative particles 710 may be generated in identical sizes for each cluster, or generated in different sizes in proportion to areas of each cluster.

For example, the modeling apparatus 100 generates a key structure connected by virtual beams 730 based on material properties of representative particles in each cluster. In this example, the key structure is provided in the representative particles 710 and the virtual beams 730 connecting the representative particles 710. Remaining particles excluding the key structures and the representative particles 710 illustrated in FIGS. 7A and 7B are illustrated for representing that the representative particles 710 are generated for each cluster. The remaining particles are not concurrently generated when the key structures are generated. The virtual beams 730 may have virtual material properties to which geometries and original material properties of each cluster to be connected by the virtual beams 730 are reflected.

In an example, the modeling apparatus 100 may configure the key structure based on a mesh or a combination of representative particles instead of the virtual beams 730. When the modeling apparatus 100 configures the key structure based on the mesh or the combination of the representative particles, the mesh or the combination of the representative particles may have virtual material properties.

For example, when an ear of a rabbit doll is modeled such that the ear touches a back of the rabbit doll during pre-modeling, an ear and a back of a rabbit not connected in a real shape may be recognized as adjacent areas. In this example, the ear and the back of the rabbit may have different physical quantities, for example, non-consecutive deformation information, and the modeling apparatus 100 may not perform the connecting between each cluster including the ear and the back of the rabbit.

The modeling apparatus 100 may generate the key structure by connecting clusters of which the deformation information are consecutive among adjacent clusters, and model an internal structure, for example, a key structure even when a structure of the target object is unknown.

For example, the modeling apparatus 100 may generate the key structure by selecting a dominant rotation direction among an X-axis, an Y-axis, and a Z-axis based on a shape and material property of the target object.

The modeling apparatus 100 may calculate the deformation information per unit external force affecting a representative particle of each cluster and assign, as the virtual material property, the deformation information per unit external force to the representative particle of a corresponding cluster. In addition, the modeling apparatus 100 may calculate a force of gravity, an interaction force by a fluid, and deformation information by an elastic force applicable to a predetermined unit of a representative particle and assign the force of gravity, the interaction force by a fluid, and the deformation information by the elastic force to the representative particle of a corresponding cluster.

As illustrated in FIG. 7, sizes and arrangements of all clusters configuring the target object may vary. In this case, a degree of deformation may vary based on the sizes and the arrangements of the clusters even when an identical external force is applied to the virtual beams 730 connecting different representative particles. The modeling apparatus 100 may numerically calculate the deformation information per unit external force for each adjacent cluster connected to each other and assign virtual material property to a representative particle of a corresponding cluster.

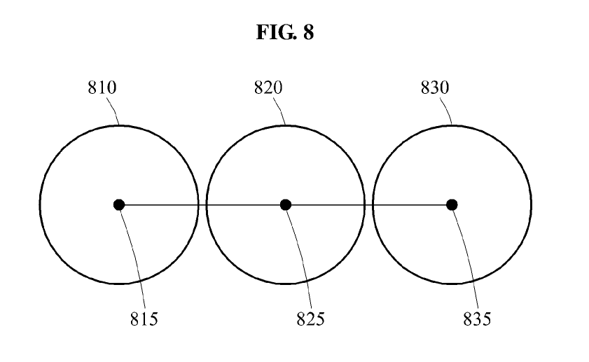

FIG. 8 is a diagram illustrating an example of a method of calculating a weighting between a representative particle and adjacent particles.

Referring to FIG. 8, a first cluster 810, a second cluster 820, and a third cluster 830 are illustrated. A representative particle 815 is generated in the first cluster 810, a representative particle 825 is generated in the second cluster 820, and a representative particle 835 is generated in the third cluster 830. The first cluster 810 neighbors the second cluster 820, and the second cluster 820 neighbors the third cluster 830.

The modeling apparatus 100 calculates a weighting quantifying an influence of a representative particle on adjacent particles. The modeling apparatus 100 calculates a weighting based on distances between a representative particle and all adjacent particles within a range in which the representative particle exhibits an effect. For example, the modeling apparatus 100 may calculate the weighting by applying a kernel function to the distances between the representative particle and the adjacent particles.

In such an example, the adjacent particles may be particles included in an identical cluster with a representative particle, and particles or a representative particle included in an adjacent cluster.

For example, a range in which the representative particle 815 of the first cluster 810 exhibits an effect may include the first cluster 810 including the representative particle 815, the second cluster 820 neighboring the first cluster 810 connected by a beam, and the third cluster 830 connected to the second cluster 820 by a beam.

The weighting may be used for restoring an entire movement of the target object by the modeling apparatus 100 in the aforementioned run-time processor 130. For example, when the target object is modeled based on particles, the modeling apparatus 100 may restore all particles indicating entire movements of the target object from a key structure of the target object. In this example, all particles may have weightings based on distances from representative particles included in respective clusters that include respective particles. All particles may also have weightings based on distances from representative particles included in respective adjacent clusters connected by beams.

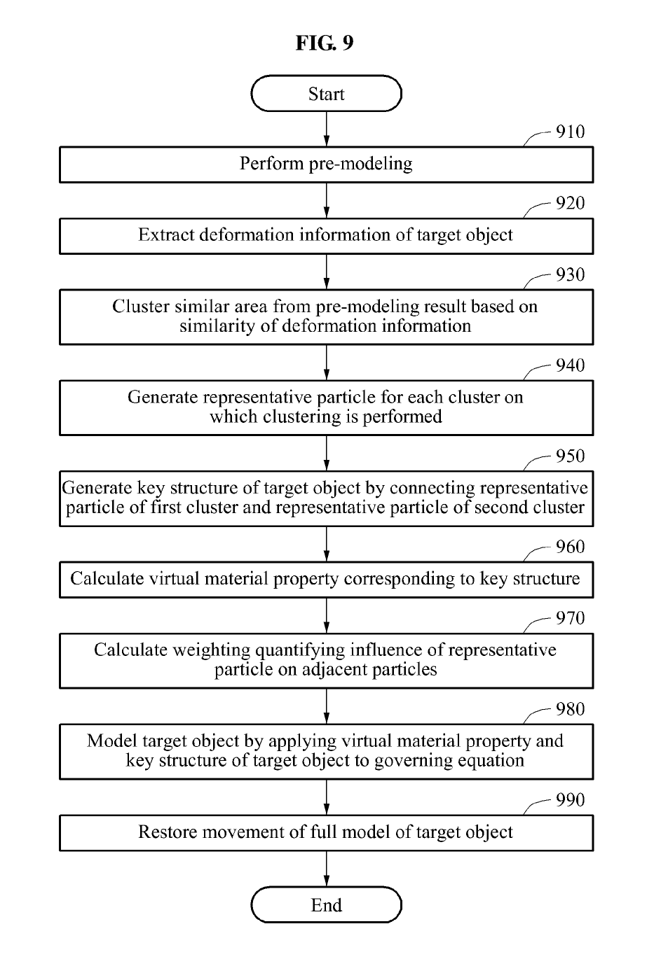

FIG. 9 is a diagram illustrating an example of a method of modeling a target object. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently. The above descriptions of FIGS. 1-8 is also applicable to FIG. 9, and is incorporated herein by reference. Thus, the above description may not be repeated here.

Referring to FIG. 9, in 910, the modeling apparatus 100 performs pre-modeling based on a shape and a material property of a target object. In 920, the modeling apparatus 100 extracts deformation information of the target object from a pre-modeling result.

In 930, the modeling apparatus 100 clusters a similar area from the pre-modeling result based on a similarity of the deformation information.

In 940, the modeling apparatus 100 generates a representative particle for each cluster on which the clustering is performed.

In 950, the modeling apparatus 100 generates a key structure of the target object by connecting a representative particle of a first cluster and a representative particle of a second cluster neighboring the first cluster.

In 960, the modeling apparatus 100 calculates a virtual material property corresponding to the key structure. The modeling apparatus 100 calculates the deformation information per unit external force affecting the representative particle and assign, as the virtual material property, the deformation information per unit external force to the representative particle.

In 970, the modeling apparatus 100 calculates a weighting quantifying an influence of the representative particle on adjacent particles.

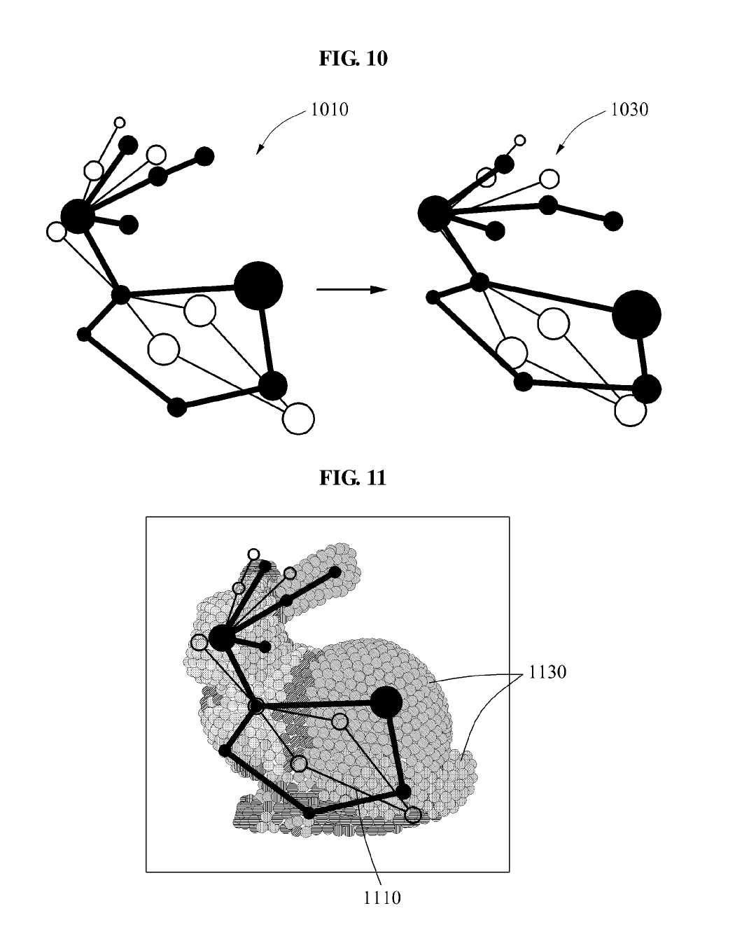

In 980, the modeling apparatus 100 models the target object by applying the virtual material property and the key structure of the target object to a governing equation. The application of a governing equation will be described with reference to FIG. 10.

In 990, the modeling apparatus 100 restores a movement of a full model of the target object based on the weighting calculated in 970, and a movement of the key structure of the target object modeled in 980. For example, when the deformation information and the movement of the full model of the target object are obtained at time t1 in 980, the modeling apparatus 100 may restore a deformation and the movement of the full model at the time t1 based on the obtained information.

For example, in a run-time processing process, the modeling apparatus 100 may model deformations and movements of entire particles configuring a full model by weighted summing obtained information, for example, movement and deformation information on a key structure. In this example, the modeling apparatus 100 may model degrees of deformations and movements of entire particles configuring the full model by applying the weighting calculated in a pre-processing process to adjacent particles affected by each representative particle configuring a key configuration. The modeling apparatus 100 may perform the modeling in 980 and the restoring in 990 for every preset time unit, for example, a time step. A result of the restoring the movement of the full model of the target object by the modeling apparatus 100 will be described with reference to FIG. 11.

FIG. 10 is a diagram illustrating an example of a method of modeling a target object by applying a governing equation.

FIG. 10 illustrates an example of a result of modeling a key structure obtained using a governing equation by the modeling apparatus 100. The modeling apparatus 100 may obtain deformation information and a movement of a key structure 1030, for example, at a time t1 and a time t2, by calculating the governing equation based on a virtual material property and a key structure 1010 of the target object obtained based on a pre-computation. In this example, the governing equation refers to an equation to govern a predetermined natural phenomenon. For example, when a phenomenon is governed by forces and motions and is based on an equation of motions F=ma, the equation of motions F=ma may be a governing equation with respect to the phenomenon of the forces and motions. Bernoulli's equation or an equation with respect to a mass flow, for example, mass flow=mass*velocity*cross section, may be a governing equation with respect to an incompressible fluid, such as a liquid. A Navier-Stokes equation may be a governing equation with respect to a water flow or an air flow.

In a modeling process, the modeling apparatus 100 may apply the virtual material property calculated in the pre-processing process to the key structure and compute the movement of the target object similar to an actual movement by calculating the governing equation targeting the key structure to which the virtual material property is applied.

FIG. 11 illustrates an example of a full restoration result.

FIG. 11 illustrates an example of a result of restoring a movement of a full model of a target object by the modeling apparatus 100.

The modeling apparatus 100 may compute a deformation and the movement of the target object for every frame corresponding to a time step. The modeling apparatus 100 may perform full restoration of the target object based on a modeling result of a key structure for every time step. In this example, the full restoration may be a restoration of all particles configuring the target object when the key structure of the target object is modeled based on particles.

For example, the modeling apparatus may restore the full model of the target object at a time t1 by modeling all remaining particles 1130 excluding the key structure 1110 in addition to a key shape, for example, the key structure 1110 in which movements and deformations in representative particles are modeled at the time t1.

FIG. 12 is a diagram illustrating an example of an apparatus for modeling a target object.

Referring to FIG. 12, a modeling apparatus 1200 includes a memory 1210 and a processor 1230.

The memory 1210 stores a shape and a material property of a target object. The shape and material property of the target object may be updated.

The processor 1230 generates a key structure of the target object and a virtual material property corresponding to the key structure based on deformation information of the target object extracted from a pre-modeling result based on the shape and the material property of the target object. The processor 1230 includes a pre-processor 1233 and a modeler 1236.

The pre-processor 1233 generates the key structure of the target object based on the deformation information of the target object extracted from the pre-modeling result based on the shape and the material property of the target object.

The pre-processor 1233 calculates the virtual material property corresponding to the key structure. The pre-processor 1233 calculates the virtual material property suitable for elements configuring the key structure.

The modeler 1236 models the target object based on the key structure of the target object and the virtual material property.

The pre-processor 1233 determines a modeling set for observing a deformation of the target object based on the shape and the material property of the target object and perform pre-modeling on the modeling set.

The pre-processor 1233 clusters a similar area from the pre-modeling result based on a similarity of the deformation information and generates a representative particle for each cluster on which the clustering is performed. The pre-processor 1233 generates the key structure of the target object by connecting a representative particle of a first cluster on which the clustering is performed and a representative particle of a second cluster neighboring the first cluster.

The pre-processor 1233 calculates the deformation information per unit external force affecting a representative particle and assigns, as the virtual material property, the deformation information per unit external force to the representative particle.

The pre-processor 1233 calculates a weighting quantifying an influence between the representative particle and adjacent particles. The modeler 1236 restores a movement of the target object by assigning the weighting to the representative particle and the adjacent particles.

The modeler 1236 models the target object by applying the virtual material property and the key structure of the target object to a governing equation.

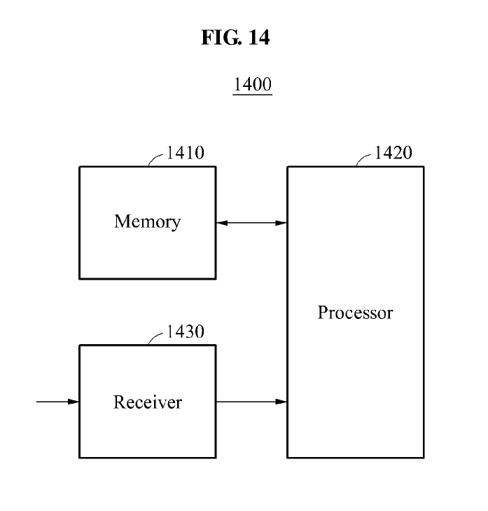

For example, the modeling apparatus 1200 may be included or inter-connected to various digital devices, such as, for example, a mobile device, and provide a movement of a target object having a sense of reality in real-time for image applications. In an example, the modeler 1236 may be provided in an additional restoring apparatus differentiated from the modeling apparatus 1200. An example of the modeler 1236 provided as an additional restoring apparatus will be described with reference to FIG. 14.

As a non-exhaustive illustration only, the mobile device described herein may refer to devices such as, for example, a cellular phone, a smart phone, a wearable smart device (such as, for example, a ring, a watch, a pair of glasses, glasses-type device, a bracelet, an ankle bracket, a belt, a necklace, an earring, a headband, a helmet, a device embedded in the cloths), a personal computer (PC), a laptop, a notebook, a subnotebook, a netbook, or an ultra-mobile PC (UMPC), a tablet personal computer (tablet), a phablet, a mobile internet device (MID), a personal digital assistant (PDA), an enterprise digital assistant (EDA), a digital camera, a digital video camera, a portable game console, an MP3 player, a portable/personal multimedia player (PMP), a handheld e-book, an ultra mobile personal computer (UMPC), a portable lab-top PC, a global positioning system (GPS) navigation, a personal navigation device or portable navigation device (PND), a handheld game console, an e-book, and devices such as a high definition television (HDTV), an optical disc player, a DVD player, a Blue-ray player, a setup box, robot cleaners, a home appliance, content players, communication systems, image processing systems, graphics processing systems, or any other consumer electronics/information technology (CE/IT) device, or any other device capable of wireless communication or network communication consistent with that disclosed herein.

FIG. 13 is a diagram illustrating an example of a method of restoring a target object. The operations in FIG. 13 may be performed in the sequence and manner as shown, although the order of some operations may be changed or some of the operations omitted without departing from the spirit and scope of the illustrative examples described. Many of the operations shown in FIG. 13 may be performed in parallel or concurrently. The above descriptions of FIGS. 1-12 is also applicable to FIG. 13, and is incorporated herein by reference. Thus, the above description may not be repeated here.

Referring to FIG. 13, in 1310, an apparatus for modeling target object, hereinafter, referred to as a “restoring apparatus”, receives a key structure of a target object and a virtual material property corresponding to the key structure from the modeling apparatus or an additional server. The restoring apparatus may receive a weighting quantifying an influence between particles in the key structure, in addition to the key structure of the target object and the virtual material property. The key structure may be generated based on at least one element of a particle, a beam based on a physical connectivity between particles, and a 3D mesh.

The key structure of the target object may be generated by clustering a similar area from a pre-modeling result based on deformation information, generating a representative particle for each cluster on which the clustering is performed, and connecting a representative particle of a first cluster on which the clustering is performed and a representative particle of a second cluster neighboring the first cluster. The virtual material property may include deformation information per unit external force affecting a particle included in the key structure.

In 1320, the restoring apparatus deforms the key structure and the virtual material property by applying the key structure and the virtual material property to a governing equation corresponding to an external force applied to the target object.

In 1330, the restoring apparatus restores the target object to which the governing equation is applied based on the deformed key structure and the deformed virtual material property. The restoring apparatus may restores the target object to which the governing equation is applied based on the deformed key structure, the deformed virtual material property, and the weighting.

FIG. 14 is a diagram illustrating an example of an apparatus for restoring a target object.

Referring to FIG. 14, a restoring apparatus 1400 includes a memory 1410, a processor 1420, and a receiver 1430.

The memory 1410 stores a key structure of a target object and a virtual material property corresponding to the key structure. The key structure of the target object and the virtual material property corresponding to the key structure may be received from another modeling apparatus through the receiver 1430.

The processor 1420 deforms the key structure and the virtual material property by applying the key structure and the virtual material property stored in the memory 1410 to a governing equation corresponding to an external force applied to the target object. The processor 1420 restores the target object to which the governing equation is applied based on the deformed key structure and the deformed virtual material property.

The various modules, elements, and methods described above may be implemented using one or more hardware components, which includes one or more software components for performing the function described above.

The apparatuses, units, modules, devices, and other components illustrated that perform the operations described herein with respect to FIGS. 1, 12, and 14 are implemented by hardware components. Examples of hardware components include controllers, sensors, generators, drivers and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array (FPGA), a programmable logic array, a microprocessor, an application-specific integrated circuit (ASIC), or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The methods illustrated in FIGS. 2-11 and 13 that perform the operations described herein with respect to FIGS. 1, 12, and 14 are performed by a processor or a computer as described above executing instructions or software to perform the operations described herein.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of modeling a target object, the method comprising:
extracting deformation information of a target object from a result of pre-modeling based on a shape and a material property of the target object;
generating a key structure of the target object based on the deformation information; and
calculating a virtual material property corresponding to the key structure.

2. The method of claim 1, wherein the extracting of the deformation information of the target object comprises,
determining a modeling set for observing a deformation of the target object based on the shape and the material property of the target object; and
performing the pre-modeling on the modeling set.

3. The method of claim 2, wherein the determining of the modeling set comprises determining the modeling set based on at least one of a force of gravity, an external user force, an interaction force by a fluid, or an elastic force applicable to the target object.

4. The method of claim 1, wherein the deformation information comprises at least one of rotation information or stretch information on elements configuring the target object.

5. The method of claim 1, wherein the generating of the key structure comprises generating the key structure based on at least one element of a particle, a beam based on a physical connectivity between particles, or a three-dimensional (3D) mesh.

6. The method of claim 1, wherein the generating of the key structure of the target object comprises:
clustering a similar area from the result of the pre-modeling based on the deformation information;
generating a representative particle for each cluster on which the clustering is performed; and
generating the key structure by connecting a representative particle of a first cluster on which the clustering is performed to a representative particle of a second cluster neighboring the first cluster.

7. The method of claim 6, wherein the clustering comprises clustering the similar area from the result of the pre-modeling based on a similarity of the deformation information.

8. The method of claim 6, wherein the generating of the representative particle comprises:
calculating a center of gravity in the cluster; and
generating the representative particle at a position corresponding to the center of gravity.

9. The method of claim 6, wherein the generating of the key structure comprises:
generating the key structure of the target object by connecting the representative particle of the first cluster to the representative particle of the second cluster, in response to the deformation information between the representative particle of the first cluster and the representative particle of the second cluster being consecutive.

10. The method of claim 6, wherein the calculating of the virtual material property comprises:
calculating deformation information per unit external force affecting the representative particle; and
assigning, as the virtual material property, the deformation information per unit external force to the representative particle.

11. The method of claim 6, further comprising calculating a weight to quantify an influence of the representative particle on adjacent particles within a range in which the representative particle exhibits an effect.

12. The method of claim 11, wherein the range in which the representative particle exhibits an effect comprises at least one of:
the second cluster neighboring the first cluster including the representative particle; or
a third cluster connected to the second cluster.

13. A non-transitory computer-readable storage medium storing a program for causing a processor to perform the method of claim 1.

14. A method of restoring a target object, the method comprising:
receiving a key structure of a target object and a virtual material property corresponding to the key structure;
applying the virtual material property and the key structure to a governing equation corresponding to an external force applied to the target object to deform the virtual material property and the key structure; and
restoring the target object to which the governing equation is applied based on the deformed virtual material property and the deformed key structure.

15. The method of claim 14, further comprising:
receiving a weight to quantify an influence between particles in the key structure,
wherein the restoring of the target object comprises restoring the target object based on the deformed key structure, the deformed virtual material property, and the weight.

16. The method of claim 14, wherein the key structure is generated based on at least one element of a particle, a beam based on a physical connectivity between particles, or a three-dimensional (3D) mesh.

17. The method of claim 14, wherein the key structure of the target object is generated by clustering a similar area from a result of pre-modeling based on the deformation information, generating a representative particle for each cluster on which the clustering is performed, and connecting a representative particle of a first cluster on which the clustering is performed to a representative particle of a second cluster neighboring the first cluster.

18. The method of claim 14, wherein the virtual material property comprises deformation information per unit external force affecting a particle comprised in the key structure.

19. An apparatus for modeling a target object, the apparatus comprising:
a memory configured to store a shape and a material property of a target object; and
a processor configured to extract deformation information of the target object from a result of premodeling based on the shape and the material property of the target object, to generate a key structure of the target object based on the deformation information, and to calculate a virtual material property corresponding to the key structure.

20. An apparatus for restoring a target object, the apparatus comprising:
a memory configured to store a key structure of a target object and a virtual material property corresponding to the key structure; and
a processor configured to deform the virtual material property and the key structure by applying the virtual material property and the key structure to a governing equation corresponding to an external force applied to the target object, and to restore the target object to which the governing equation is applied based on the deformed virtual material property and the deformed key structure.
